(19) United States
(12) Patent Application Publication
(10) Pub. No.: US 2017/0030359 A1
(43) Pub. Date: Feb. 2, 2017

(54) BATCH CHANGE CONTROL FOR VARIABLE SPEED DRIVEN CENTRIFUGAL PUMPS AND PUMP SYSTEMS

(71) Applicant: SIEMENS AKTIENCESELLSCHAFT, MUNCHEN (DE)

(72) Inventors: Edward A. Fowler, Houston, TX (US); Gerd Klöppner, Baiersdorf (DE); Ganesh Kumar Seeniraj, Farmington Hills, MI (US); Raphael Rhote-Vaney, Novi, MI (US)

(21) Appl. No.: 14/814,978

(22) Filed: Jul. 31, 2015

(51) Int. Cl. F04D 15/00; F17D 3/03; F04D 13/06; F04D 1/06; F04D 7/04

(52) U.S. Cl. CPC F04D 15/0066; F04D 1/06; F04D 7/04; F04D 13/06; F17D 3/03

(57) ABSTRACT

A pump system includes an interface detection meter arranged at a pipeline assembly, a drive assembly for controlling speed of a pump arranged at the pipeline assembly, a discharge pressure control assembly and/or flow control assembly for controlling discharge pressure of the pump system, and a control assembly operably coupled to the drive assembly and/or the discharge pressure control assembly and/or the flow control assembly. A logic control of the control assembly receives fluid data of fluid in the pipeline assembly provided by the interface detection meter, and forwards the fluid data for calculating speed set points for the drive assembly and/or discharge pressure control parameter and/or set points for the discharge pressure control assembly, and/or flow rate control set points for the flow control assembly. A method for controlling variable speed driven pumps or pump systems during batch change and an embodiment of a plug-and-play device are disclosed.

### BACKGROUND

1. Field

Aspects of the present invention generally relate to a method and systems for batch change control for variable speed-driven centrifugal pumps and pump systems.

2. Description of the Related Art

Pumps and pump systems are operated in applications for different media types, for example fluids, slurries, etc., and for different batches, generally in the process industry, and in particular in the oil and gas industry, for example pipelines, refineries, tank farms, etc. Typical oil pipelines transport batches of different types of oil. Such batches include light weight oils and heavy weight oils such as for example light crude oil, diluted bitumen oil, and synthetic crude oil with wide ranges of relative densities and viscosities. Batches can be of different products and of different grades of the same product. Batch changes can occur frequently as often as several times per day.

There are different methods used to separate oil batches, for example pig separation of batches, liquid slug separation of batches, and back-to-back batch changes. When using the back-to-back batch change method, no separation equipment such as for example utility pigs, is required. Three distinct volume areas exist in the pipeline when two oil batches, for example two product grades, are flowing. The new batch and the old batch have their own unique fluid properties. The volume between the new and old batches is called the interface; the interface volume represents a mixture of the new batch and the old batch with transient fluid properties (e.g. densities, viscosities). The length of the interface in the pipeline is shortest near the point of introduction of the new batch and longest at the delivery point. Flows and velocities of the different oil batches are kept at magnitudes sufficient to maintain turbulent flow in the pipeline. With adequate turbulence, minimum mixing of the product (interface) is accomplished.

But there are hydraulic and power disturbances when heavy-to-light and light-to-heavy interfaces move into centrifugal pumps. Thus, there exists a need to minimize hydraulic and power disturbances due to viscosity and/or density transients during batch changes in order to maintain economical and safe pump operation as well as mechanical and e.g. electrical integrity of the system, in particular to control pump speed and/or discharge pressure and/or flow rate and to control a pump station discharge pressure during batch changes.

### SUMMARY

Briefly described, aspects of the present invention relate to a method and systems for batch change control for variable speed-driven centrifugal pumps and pump systems. Variable speed drives as disclosed herein includes electrical and mechanical assemblies (e.g. gear boxes, turbines).

A first aspect of the present invention provides a pump system comprising a pipeline assembly for transporting fluid; a pump assembly comprising a plurality of pumps arranged along the pipeline assembly; a pump motor assembly comprising a plurality of pump motors, for example electric pump motors, driving the plurality of pumps of the pump assembly; a control assembly for controlling speed of at least one pump motor and discharge pressure of at least one pump; and at least one interface detection meter in communication with the pipeline assembly, the interface detection meter determining properties of the fluid in the pipeline assembly, in particular in front of pump suction nozzles of the at least one pump, and the control assembly controlling the speed and/or the discharge pressure and/or flow rate of the at least one pump according to the properties determined of the fluid in the pipeline assembly.

A second aspect of the present invention provides a control system comprising at least one interface detection meter in communication with a pipeline assembly for transporting fluid; a drive assembly controlling speed of at least one pump motor powering at least one pump in communication with the pipeline assembly for transporting the fluid; and a feed forward control assembly controlling pump speed and/or discharge pressure and/or flow rate of the at least one pump, wherein a first logic control of the control assembly receives fluid data of the fluid in the pipeline assembly provided by the at least one interface detection meter, and forwards the fluid data to a second logic control for calculating speed set points and/or discharge pressure set points and/or flow rate set points for the feed forward control assembly.

A third aspect of the present invention provides a method for controlling variable speed driven pumps or pump systems comprising acquiring real-time fluid data by field instruments of a fluid travelling through a pipeline assembly, and acquiring operational data of a pump system by different units of the pump system, the pump system being operably coupled to the pipeline assembly; transferring acquired fluid data and operational data to logic controls of the pump system; processing the acquired fluid data and operational data by the logic controls; overriding basic pump controls of the pump system based on results provided by the logic controls after the processing of the acquired fluid data and operational data; and resetting the basic pump controls.

### BRIEF DESCRIPTION OF THE DRAWINGS

FIG. 1 illustrates an example pump station constructed in accordance with an exemplary embodiment of the present invention.

FIG. 2 illustrates a diagram illustrating transition of an operating point during a batch change in accordance with an exemplary embodiment of the present invention.

FIG. 3 illustrates an example pump station of a pump system constructed in accordance with an exemplary embodiment of the present invention.

FIG. 4 illustrates an example of a plug and play device for a pump and pump systems constructed in accordance with an exemplary embodiment of the present invention.

FIG. 5 illustrates a flow chart of a method for controlling variable speed driven pumps or pump systems constructed in accordance with an exemplary embodiment of the present invention.

### DETAILED DESCRIPTION

In order to facilitate an understanding of embodiments, principles, and features of the present invention, these are explained hereinafter with reference to implementation in illustrative embodiments. In particular, these are described in the context of being methods and systems for a batch change control for variable speed driven centrifugal pumps and pump systems. Embodiments of the present invention, however, are not limited to use in the described devices or methods.

The components and materials described hereinafter as making up the various embodiments are intended to be illustrative and not restrictive. Many suitable components and materials that would perform the same or a similar function as the materials described herein are intended to be embraced within the scope of embodiments of the present invention.

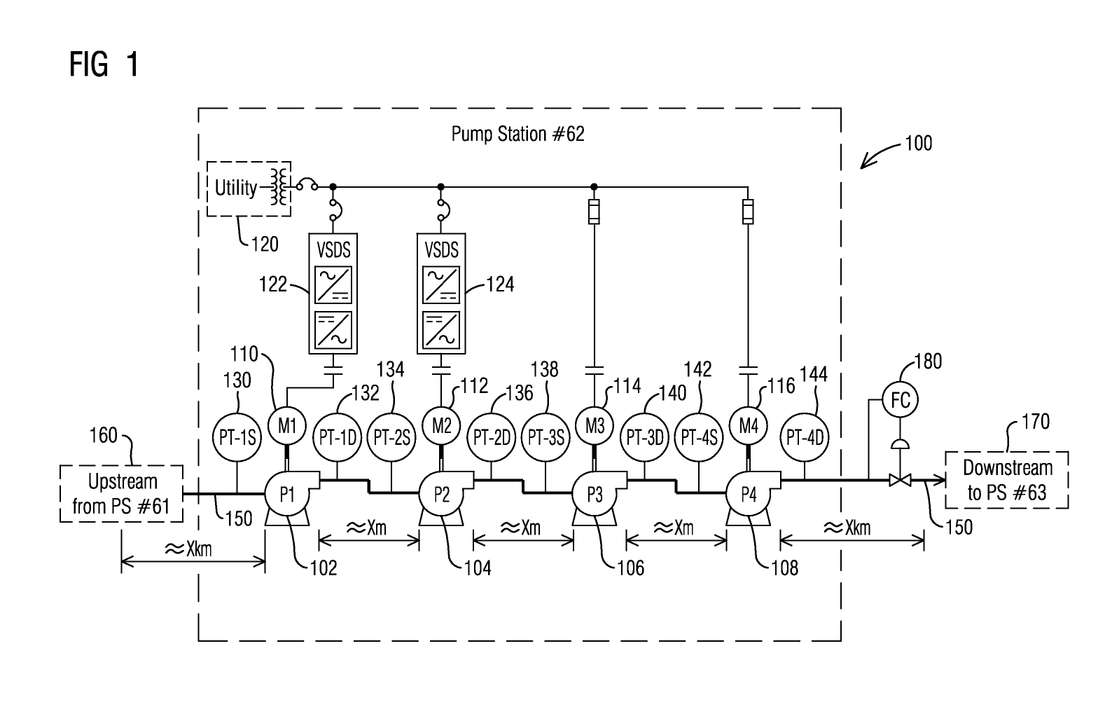

FIG. 1 illustrates an example pump station constructed in accordance with an exemplary embodiment of the present invention.

The pump station 100 as illustrated in FIG. 1 models a four-pump-in-series-station with pumps 102, 104, 106, and 108, also labelled as P1, P2, P3, and P4, for transporting a fluid, for example oil, along pipeline 150. Many other media or fluids can be transported in the pipeline 150. Each pump 102, 104, 106, 108 is driven by an electric motor, which are for example induction motors. Pump 102 is driven by pump motor 110, also labelled M1, pump 104 is driven by pump motor 112 (M2), pump 106 is driven by pump motor 114 (M3), and pump 108 is driven by pump motor 116 (M4). For example, electrical power is supplied by power supply 120, also referred to as utility. Likewise, power supply can be by generator. If required, electrical transformers transform incoming voltage to appropriate levels for the pump motors 110, 112, 114, 116.

Pumps 102, 104, 106, 108 are each configured as a centrifugal pump. In this exemplary embodiment, the power for driving the pumps 102, 104, 106, 108 is provided directly by the electric pump motors 110, 112, 114, 116.

Pumps 102, 104 are powered each by a variable speed drive, also referred to as Variable Speed Drive System (VSDS). Pump 102 is powered by VSDS 122, and pump 104 is powered by VSDS 124. The variable speed drives 122, 124 are used to control speed and torque of pump motors 110, 112. In the exemplary embodiment according to FIG. 1, each VSDS 122, 124 is operated with a fixed speed set point. Pumps 106, 108 are operated at a constant speed powered from the utility 120. Optionally, the pump station 100 can be equipped with a flow controller 180.

Pumps 102 (P1) and 104 (P2), which are powered by VSDS 122 and 124, are discharge pressure controlled using speeds of the motors 110 (M1) and 112 (M2). Thus, each pump 102, 104 comprises pressure transmitters 130, 132, 134, 136. Pressure transmitters 130, 132 monitor pressure head of pump 102, wherein pressure transmitter 130, also labelled as PT-1S, is arranged upstream of pump 102 and pressure transmitter 132, also labelled PT-1D, is arranged downstream of pump 102. Transmitter 132 is operably connected to VSDS 122 in order to control the discharge pressure of pump 102 using the speed of motor 110. As FIG. 1 shows, each further pump 104, 106, 108 comprises at least two pressure transmitters 134 (PT-25), 136 (PT-2D), 138 (PT-35), 140 (PT-3D), 142 (PT-45), 144 (PT-4D), wherein one pressure transmitter is arranged upstream of the pumps 104, 106, 108 and one pressure transmitter is arranged downstream of the pumps 104, 106, 108. But such conventional pressure/speed controlling of the pumps 102, 104, 106, 108 is not able to control instantaneous changes in media densities and viscosities in case of batch changes. As a result, surges in flow and pressure occur and upstream/downstream operations are disrupted and integrity and safe operation of equipment and the pump station 100 is compromised.

The four centrifugal pumps 102, 104, 106 and 108 of pump station 100 are arranged in series. One of ordinary skill in the art appreciates that pump station 100 can comprise more or less than four pumps, for example only one pump or ten pumps. When pump station 100 comprises more than one pump, the pumps can be arranged in series and/or in parallel and/or a combination of both.

The pump station 100 further comprises field devices to measure and monitor relevant data and manipulate operation. Such field devices comprise for example flow, pressure and temperature gauges, sensors, transmitters. Pump station 100 can comprises pressure and temperatures gauges and transmitters installed along the pipeline 150 on specific locations. A supervisory control and data acquisition system, known as SCADA system, at a main control room receives all the field data and presents the data to pipeline operators through a set of screens or other type of human-machine-interface, displaying the operational conditions of the pipeline. The operator can monitor the hydraulic conditions of the line, as well as send operational commands (open/close valves, turn on/off compressors or pumps, change set points, etc.) through the SCADA system to the field. Exemplary embodiments of the present invention integrate into such an operational environment.

The pump station 100 is labelled as pump station #62 and is part of a pump system. A pump system can comprise one ore pump stations, such as for example pump station 100 as illustrated in FIG. 1. As FIG. 1 shows, pump station 100 (#62) is connected between pump station 160 (#61) and pump station 170 (#63), wherein pump station 160 is located upstream of pump station 100 and pump station 170 is located downstream of pump station 100. Between the pump stations 100, 160 and 170 are distances of many kilometers. The distances between individual pump stations (X km) can vary, for example according to specific regional requirements. According to selected distances between pump stations, the number of individual pumps may need to be adjusted. For example, the longer the distance between pump stations, the more pumps at the pump station may be required in order to provide flow. Multiple pump stations, as for example pump stations 100, 160, 170, of a pump system can be arranged in series or parallel or in a combination of both. The pump stations 100, 160, 170 as schematically shown in FIG. 1 are arranged in series. Each pump of a pump system and/or each pump 102, 104, 106, 108 of a pump station such as pump station 100 can be either driven by a VSDS or can be powered directly by the utility 120, also referred to as direct online type (DOL). Each of the pumps 102, 104, 106, 108 can be operated on/off. When DOL operation of pumps 102, 104, 106, 108 is required, pumps 102, 104, 106, 108 are typically started using VSDs 122 and/or 124 to accelerate a pump to rated speed then transfer power to utility 120 after which VSDs 122 and/or 124 is/are disconnected from the pump and made available for use by the other pumps. Distances between individual pumps 102, 104, 106, 108 (X m) can be equal or can be different.

As described before, there are different methods used to separate oil batches. When using the back-to-back batch change method, no separation equipment such is required. Flows and velocities of the different oil batches are kept at magnitudes sufficient to maintain turbulent flow in the pipeline. With adequate turbulence, mixing of the product (interface) is kept at a minimum. But hydraulic and power disturbances start when heavy-to-light and light-to-heavy interfaces reach the inlet of a pump station.

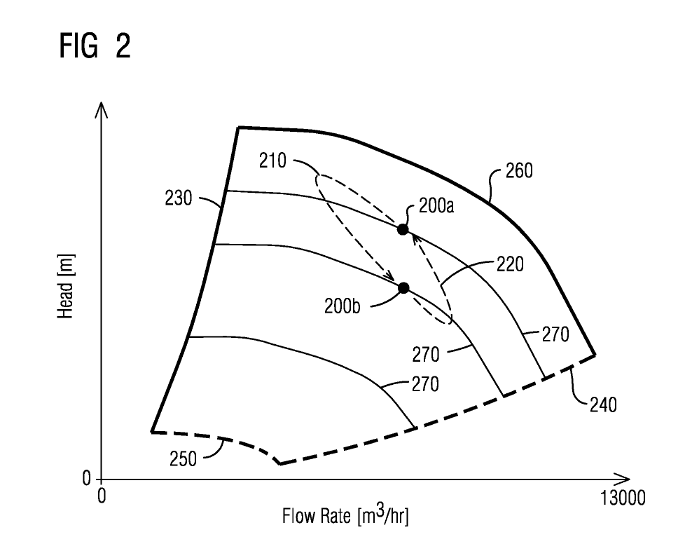

FIG. 2 illustrates transition of an operating point during a batch change in accordance with an exemplary embodiment of the present invention.

During batch changes, behaviour of operating point 200a, 200b, also referred to as invariant flow rate set point, of a pump station, as for example pump station 100 as shown in FIG. 1 within pipeline 150, is illustrated in FIG. 2. High density and high viscosity media is defined as “heavy media”. Low density and low viscosity media is defined as “light media”. FIG. 2 shows the transition of the operating point 200a, 200b for a pump station without batch change control (refer to FIG. 1).

Reference numeral 200a labels an operating point for heavy fluid, and reference numeral 200b labels an operating point for light fluid. The x-axis labels flow rate (m³/hr) of the fluid, and the y-axis labels total pump station head required (m), also referred to as total dynamic head (TDH).

Line 230 labels a minimum flow rate, and dotted line 240 labels a maximum flow rate of the fluid. Dotted curve 250 labels a minimum pump speed curve, and curve 260 labels a maximum pump speed curve, with different speed curves 270 in between. Pump curves are dependent on viscosity of the fluid and are corrected accordingly.

For example, during a batch change the flow rate is as follows:
a) In case of a batch change from heavy media to light media, the operation point 200a/b is moving as per dotted line 210 from point 200a to 200b.
b) In case of a batch change from light media to heavy media, the operation point 200a/b is moving as per dotted line 220 from point 200b to 200a.

The transition swings of the operation point 200a/b in both cases a) and b) are the more extreme the larger the differences in density and viscosity between “heavy” and “light” are and the smaller the interface length of batch changes is. Fast changes in flow rate during transition can induce pressure surges in the pump system. Timely detection of a batch change interface in front of first pump of pump station 100 (refer to FIG. 1) mitigates upsets, e.g. by means of processing the interface signals in feed forward control, and enables optimizing operation of the pump station 100 as well as of the pump system within actual operational limits and constraints.

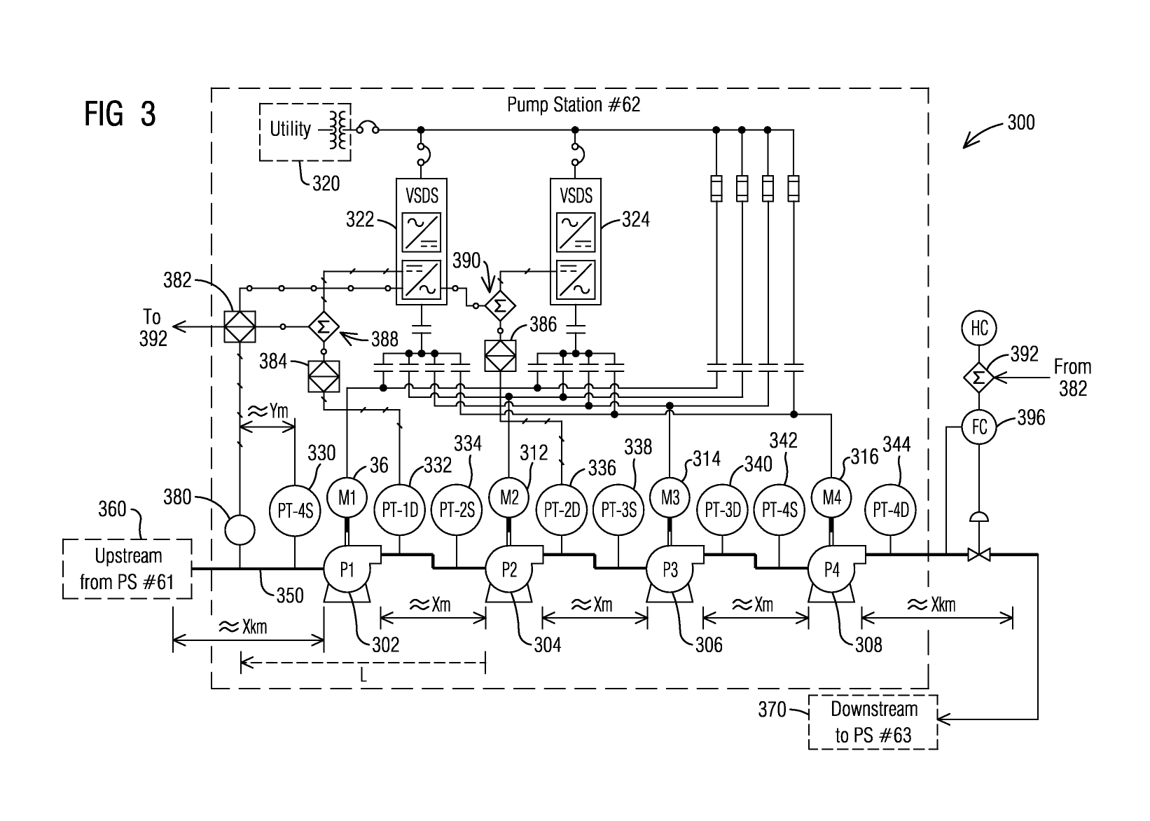

FIG. 3 illustrates an example pump station of a pump system constructed in accordance with an exemplary embodiment of the present invention.

Similarly to the pump station 100 as illustrated in FIG. 1, pump station 300 models a four-pump-in-series-station with centrifugal pumps 302, 304, 306, and 308, also labelled as P1, P2, P3, and P4, for transporting a fluid, for example oil, along pipeline 350. Each pump 302, 304, 306, 308 is driven by e.g. an induction motor. Pump 302 is driven by pump motor 310, also labelled M1, pump 304 is driven by pump motor 312 (M2), pump 306 is driven by pump motor 314 (M3), and pump 308 is driven by pump motor 316 (M4). Electrical power is supplied by power supply 320, also referred to as utility.

The pump station 300 is labelled as pump station #62 and is part of a pump system. A pump system can comprise one ore pump stations, such as for example pump station 300. As FIG. 3 shows, pump station 300 (#62) is connected between pump station 360 (#61) and pump station 370 (#63), wherein pump station 360 is located upstream of pump station 300 and pump station 370 is located downstream of pump station 300. Between the pump stations 300, 360 and 370 are distances of many kilometers (X km). The distances between individual pump stations can vary, for example according to specific regional requirements. According to selected distances between pump stations, the number of individual pumps may need to be adjusted. For example, the longer the distance between pump stations, the more pumps at the pump station may be required in order to provide flow. Multiple pump stations, as for example pump stations 300, 360, 370, of a pump system can be arranged in series or parallel or in a combination of both. The pump stations 300, 360, 370 as schematically illustrated in FIG. 3 are arranged in series. Distances between individual pumps 302, 304, 306, 308 (X m) can be equal or can be different.

As illustrated in FIG. 3, pump station 300 comprises Variable Speed Drive Systems (VSDS) 322, 324. All pumps 302, 304, 306, 308 of the pump station 300 can be powered by VSDSs 322, 324 via the pump motors 310, 312, 314, 316. Optionally, some of the pumps 302, 304, 306, 308 of the pump station 300 can be powered from utility 320. For example, pumps 306, 308 may be powered by the utility 320 or by the VSDSs 322, 324. The pump station 300 can comprise only one VSDS or can comprise more than two VSDSs. The variable speed drives 322, 324 are used to control speed and torque of pump motors 310, 312, 314, 316. As FIG. 3 shows, each pump 302, 304, 306, 306 is operably coupled to both the VSDS 322 and the VSDS 324. Each of the pumps 302, 304, 306, 308 can be operated on/off. Furthermore, some pumps and pump stations within a configuration can be switched-off/on according to pipeline operation requirements.

On the contrary to the exemplary embodiment according to FIG. 1, the exemplary embodiment according to FIG. 3 models a feed forward controlled pump station 300 with controlling the pumps 302, 304, 306, 308 along with the pump motors 310, 312, 314, 316. Pump station 300 comprises a control system with control loops for controlling the pumps 302, 304, 306, 308 in particular during batch changes.

Timely detection of a batch change interface in front of pump station 300 mitigates upsets and enables optimizing operation of the pump station 300 as well as of the pump system. According to an exemplary embodiment of the invention, pump station 300 comprises a control system in order to minimize hydraulic and power disturbance due to density and viscosity transients during batch changes and in order to maintain economical and safe pump operation as well as mechanical and e.g. electrical integrity of the pump station 300 and the pump system, in particular to maintain a constant flow rate and to manage a pump station discharge pressure during batch changes. The control system includes logic, which may be implemented in hardware, software, or a combination thereof.

Each variable speed driven pump among pumps 302, 304, 306, 308 comprises respective suction pressure transmitters 330, 334, 338, 342 and discharge pressure controllers 332, 336, 340, 344, which monitor and control the discharge pressure of a respective pump 302, 304, 306, 308. At least one or two pumps of the pump station 300 are variable speed driven and discharge pressure controlled, wherein one pressure transmitter is arranged upstream of the pumps and one pressure controller is arranged downstream of the pumps. For example, variable speed driven centrifugal pump 302 can comprise pressure transmitter 330 (PT-1S), pressure controller 332 (PT-1D), variable speed driven centrifugal pump 302 can comprise pressure transmitter 334 (PT-25), pressure controller 336 (PT-2D), variable speed driven centrifugal pump 306 can comprise pressure transmitter 338 (PT-35), pressure controller 340 (PT-3D), and variable speed driven centrifugal pump 308 can comprise pressure transmitter 342 (PT-45), pressure controller 344 (PT-4D). The exemplary pump station 300 is designed so that all pumps 302, 304, 306, 308 have closed loop discharge pressure controllers e.g. 384, 386 that can be activated when powered from VSDSs 322, 324 and de-activated when powered direct online from the utility 320. Feed forward control during batch change shall take place only on variable speed driven pumps within the pump assembly. VSDSs 322, 324 can drive any pump 302, 304, 306, 308 and when driving a specific pump, the respective pressure controller is assigned to that specific pump and operably coupled to VSDSs 322, 324 so that discharge pressure control is achieved for any pump driven by a VSDS.

Fast and accurate measurement of the properties of the fluid transported in pipeline 350 is prerequisite for a fast acting control system in order to predict interface during a batch change in first pump 302 at the pump station 300. Issues caused by delayed fluid property measurements are avoided by using e.g. a multi-variable clamp-on interface detection instrument 380 with sufficient sampling at rates such as five times per second. The instrument 380 can be for example a clamp-on transit-time ultrasonic meter. Such an ultrasonic meter is for example a device named SITRANS FUH1010® manufactured by Siemens. The instrument 380 ensures precise and timely sampling of flow rate, density and viscosity by sensoring sonic velocities and temperature of the media in the pipeline 350. The pump station 300 can comprise one or a plurality of interface detection meters 380 installed at desired locations along the pipeline 350. Typically, a pump station comprises at least one interface meter 380 installed in front of first pump 302 of the pump station 300. The optimal location of the interface meter 380 downstream of pump station 360 and upstream of pump station 300 depends on the feed forward control requirements (refer to pump suction L).

The control system encompasses comprehensive control loops including sensors, transmitters, logic software, actuators and electrical supply and analogue/digital signal interfaces. In general, logic software applications calculate (e.g. based on sensor readings, plant condition data, and system design data) the optimal transition of pump operating points from start to end of a batch change. The results are implemented to override basic control parameters and set points of the pump station.

The pump station 300 comprises feed forward logic and/or model-based predictive logic in order to supplement or override basic control commands and/or data of the pump station 300, and feed back control loops comprising a plurality of logic controllers 382, 384, 386. Logic control 382 is operably coupled between interface detection instrument 380 VSDSs 322, 324, and flow controller 396, also labelled FC. Logic control 382 comprises feed-forward control functionality and/or model-based predictive logic in order to supplement or override basic control commands of the pump station 300. Models applied include batch detection application, viscosity corrected pump curves, ultrasonic signal compensation, etc. and overriding set points and/or controller parameter of VSDS controls 388, 390 and/or flow controller 396, and/or discharge controller, e.g. 384, 386.

The interface detection instrument 380 provides sonic velocities and temperature of the fluid in the pipeline 350. In an exemplary embodiment, the interface detection instrument 380 can be configured such that it also determines and/or calculates flow rate and/or density and/or viscosity of the fluid in the pipeline 350. Alternatively, viscosity and/or density can be calculated in logic control 382 instead of being provided by the interface detection instrument 380. The logic control 382 controls the VSDSs 322, 324 and/or flow controller 396 by adjusting the speed set points and/or control parameter of each VSDS 322, 324, and/or set point and control parameter of pressure controls e.g. 384, 386, and/or set point and control parameter of flow controller 396 according to the properties, in particular viscosity and/or density, of the fluid in the pipeline 350 based on viscosity corrected pump curves of pertinent pumps. Other examples for an interface detection instrument 380 are viscosity meters and/or density meters or many other meters capable of providing viscosity and/or density information of a fluid in timely manner.

Pump station 300 further comprises logic controls e.g. 384, 386, and/or 396, wherein each logic control 384, 386, 396 comprises logic functionality, for example a PID controller. In the event of a batch change, manipulated variables (output) and/or control parameters and/or set points of these controllers 384, 386, and/or 396 are overridden by control logic 382. After the batch change, these logic controllers 384, 386, 396 are re-started accordingly and the control logic 382 is set idle.

Pump station 300 further comprises logic controls e.g. 388, e.g. 390, 392. These logic controls e.g. 388, e.g. 390, 392 override logic controls e.g. 384, 386 and/or the set point of logic control 396 by means of results/output of logic control 382, if applicable during a batch change.

Based on information relating to density and/or viscosity of the fluid in the pipeline, the logic control 382 detects timely batch changes. During a batch change, the logic control 382 predicts optimal pump and pump system operation based on design limits and actual operational data and constraints (e.g. including electro-mechanical system data) and/or actual viscosity corrected pump curves (refer to FIG. 2) and overrides speed settings for VSDSs 322, 324 and/or parameter of pressure logic controls 384, 386, and/or set points of flow controller 396. Once a batch change is accomplished, pressure/speed logic controls e.g. 384, 386 and/or flow control logic 396 is/are re-activated accordingly.

In further exemplary embodiments, the logic control 382 calculates the speed set points for VSDSs 322, 324 and/or set points and parameters of discharge pressure controllers e.g. 384, 386, and/or set points for flow controller 396 derived dynamically from a multi-dimensional system of equations or lookup tables based on viscosity corrected pump system curves, design limits, actual operational constraints and conditions of pump and pump system (e.g. including electro-mechanical systems). The calculated speed and/or discharge pressure control parameter and/or set points and/or flow rate set points are functions of multiple variables, for example:

Fluid density and viscosity, compressibility factors,

Volumetric flow rate,

Crude assays and pump curves,

Pressure and temperature of fluid,

Suction/discharge pressure of pumps and pumps systems,

Batch interface length, and

Theoretical and calculated actual pump efficiencies.

As noted before, each of the pumps 302, 304, 306, 308 can be operated on/off. For example, according to flow rate of fluid in pipeline 350 and discharge pressure of pumps 302, 304, 306, 308, one or more of the pumps may be switched off because the flow rate and discharge pressure is such that not all of the pumps are needed. When the flow rate and discharge pressure requirements increase, the pumps can be switched on again.

The control logic of the control system comprises at least the following functionalities:
Detecting batch changes by logic control 382.
Logic control 382 overrides signals and/or parameter of logic controls e.g. 384, e.g. 386, 396. This may include e.g. time lag, ramping, scaling, controller parameters, set points
Overriding the set points of pump system controls (e.g. pump system discharge pressure control, pump system suction control, pump system flow control) depending on interface transient change in properties and period time of interface transient.
Real-time sensor readings shall be processed, e.g. sample times of about 200 ms, including compressibility factors of media (refer to interface detection instrument 380).
Pump curves, e.g. total pump head=f (flow, speed, viscosity), shall be continuously updated (refer to for example FIG. 2) depending on actual pump condition monitoring and known corrections for viscosity, density, impeller, max. shaft power, etc. Actual pump curves are applied for pump station operation and optimization, if applicable. Actual pump efficiencies and/or maintenance information is applied in order to decide on optimal pump configurations (e.g. pump on/off).
Based on actual pump conditions and batch interface information as well as operational constraints (e.g. pump on/off, minimum pump flows, choke flows, min/max speeds, max electrical current, availability and actual condition of mechanical, electrical and instrumentation loop devices and equipment), the optimized transient towards the new steady-state operation of pump station can be calculated and implement into the basic controls (speed control, discharge/suction control, flow control) of the control system by means of for example model-based or model-predictive process control logic.
Depending on actual feasibility and requirements steady-state modeling (ODE, ordinary differential equation), dynamic modeling (PDE, partial differential equation), mixed integer modeling, fuzzy logic, stochastic/empirical modeling and artificial neural networks are applicable. Hybrid modeling of above-mentioned (e.g. dynamic modeling with artificial neural network modules etc.) is also included.

Essentially, the control system of pump station 300 monitors the flow rate of the fluid in the pipeline 350 as well as density and viscosity of the fluid in real time. A fluid interface of a batch change can be detected and speed set points for the VSDSs 322, 324 and/or set points and parameters for discharge pressure controls e.g. 384, 386 are automatically adapted when the fluid interface enters each pump 302, 304, 306, 308 of the pump station 300. The control system also calculates correct station pressure set points for at least pumps 302, 304, and discharge pressure controllers e.g. 384, 386 and/or flow controller 396 for non-batch change conditions. The control system mitigates the transient effects on the hydraulic and power systems when batch changes occur, in particular when batch changes with oil viscosity changes occur. The control system as described in FIG. 3 employs high speed product monitoring, for example density, pressure, temperature and viscosity (refer to interface detection instrument 380) and control algorithms implemented in one or more of logic controls 382, 38, 386, 392, and other devices to attenuate magnitudes of disturbances during batch changes.

The control circuit as illustrated in FIG. 3 attenuates the operation paths 210, 220 (refer to FIG. 2). By reducing (or increasing) the speed set points of VSDSs 322, 324, and/or discharge pressure control 384, 386, and/or flow control 396 synchronized with the position of the interface, pressure and flow are maintained. The speed set points of VSDSs 322, 324 are adjusted as the new batch of fluid travels downstream the pipe 350 in order to maintain a flow rate according to the downstream pressure requirements. The control circuit as illustrated in FIG. 3 prevents the operating point 200a, 200b (refer to FIG. 2) from shifting from 200a to 200b along paths 210, 220; instead the control system allows operating point 200b to move to operating point 200a (and vice versa) almost vertically to maintain flow and control discharge pressures.

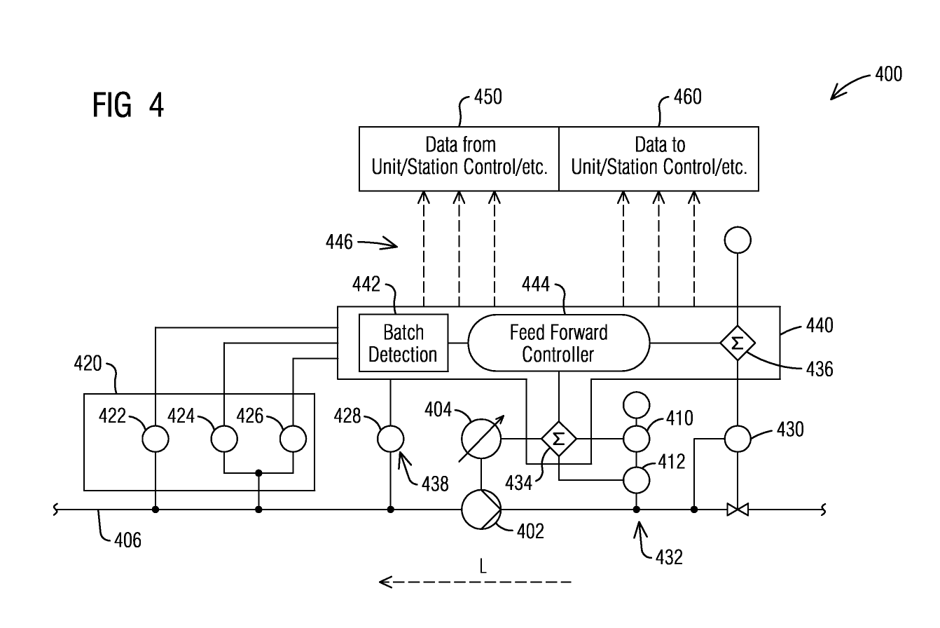

FIG. 4 illustrates an example of a plug-and-play device for a pump and pump systems constructed in accordance with an exemplary embodiment of the present invention.

The described control system can be integrated into new pump stations or pump system when being installed (refer to for example FIG. 3), referred to as Greenfield projects, or can be installed as plug-and-play system as retrofit application into existing infrastructure, referred to as Brownfield projects.

FIG. 4 illustrates a section of a pump system 400 which comprises one variable speed driven pump 402, one variable speed drive system (VSDS) 404, discharge pressure-speed control 410, interface detection meter 420 and/or flow controller 430, and pipeline assembly 406 transporting fluid. Plug-and-play device 440 comprising feed forward batch change controller 444 is integrated into the pump system 400 which is an existing system configuration, i.e. Brownfield project, via data and signal interfaces 446. Plug-and-play device 440 interfaces to plant and other outside system data import 450 and data export 460 of the pump system 400 via interfaces 446. In doing so, a set of further controllers of different types, for example at further pumps, can be coordinated and aligned with the plug-and-play device 440.

Plug-and-play device 440 processes pump suction information such as for example fluid temperature 422, fluid density 426, fluid flow rate 424 provided by interface detection meter 420 and suction pressure information 428 provided by pressure transmitter 438, as well as pump discharge information 410, 412 provided by pressure transmitter 432 and/or flow controller 430. Pump system 400 further comprises logic controls 434, 436, which override existing logic control 410 and/or set points of logic control 430 by means of results/output of logic control of feed forward controller 444, if applicable during batch change detection 442.

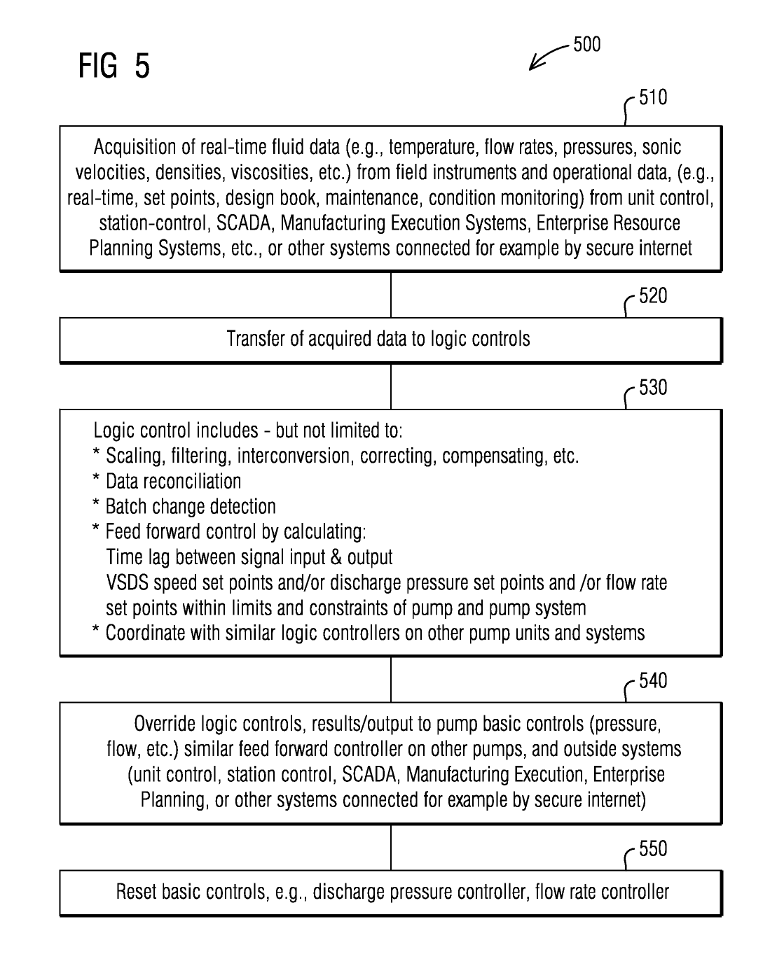

FIG. 5 illustrates a flow chart of a method 500 for controlling variable speed driven pumps or pump systems, as described for example in FIG. 3 and FIG. 4, constructed in accordance with an exemplary embodiment of the present invention.

Step 510 of method 500 comprises acquisition of real-time fluid data (e.g. temperatures, flow rates, pressures, sonic velocities, densities, viscosities, etc.) from field instruments and operational data (e.g. real-time, set points, design book, maintenance, condition monitoring) from unit control, station control, SCADA, Manufacturing Execution Systems, Enterprise Resource Planning Systems, etc., or other systems connected for example by secure internet. In step 520, acquired data are transferred to logic controls of a pump station or pump system. The logic controls include, but are not limited to (see step 530):

Scaling, filtering, inter-conversion, correcting, compensating, etc.,

Data reconciliation,

Batch change detection,

Feed forward control by calculating,
Time lag between signal input & output,
VSDS speed set points and/or discharge pressure set points and/or flow rate set points within limits and constraints of pump and pump system,

Coordinating with similar logic controllers on other pump units and systems.

Step 540 includes forwarding and overriding the results/output of the logic controls (refer to steps 520, 530) of the pump station or pump system to pump basic controls (pressure, flow, etc.), and forwarding and overriding results/output of feed forward controller to other pumps and outside systems (for example unit control, station control, SCADA, Manufacturing Execution, Enterprise Planning, or other systems connected for example by secure internet). In step 550, when a batch change is over, basic pump controls, e.g. discharge pressure controller and/or flow rate controller are reset.

The proposed control system optimizes by means of logic application (mathematical algorithm) based on plant, design data (incl. viscosity corrections of pump curves) the transition upsets of operations, minimizes the transition time and maintains safe pump and plant operation by processing timely interface sensor signals in order to predict new operation set points and control parameters, as well as optimal path of transient operation. This includes switching discrete pumps on/off and adjusting speed of pumps as well as overriding, ramping set points and control parameters of basic controls, if applicable. The mathematical algorithm includes—but is not limited to—algebraic equations, ordinary differential equations, partial differential equations, mixed integer equations, and a combination thereof.

The described control system can be integrated into new pump stations 300 or pump system when being installed, referred to as so called Greenfield projects, or can be installed as plug-and-play system as retrofit application into existing infrastructure, referred to as so called Brownfield projects.

While embodiments of the present invention have been disclosed in exemplary forms, it will be apparent to those skilled in the art that many modifications, additions, and deletions can be made therein without departing from the spirit and scope of the invention and its equivalents, as set forth in the following claims.

What is claimed is:

1. A pump system comprising:
a pipeline assembly for transporting fluid;
a pump assembly comprising a plurality of pumps arranged along the pipeline assembly;
a pump motor assembly comprising a plurality of pump motors driving the plurality of pumps of the pump assembly;
a control assembly for controlling speed of at least one pump motor and discharge pressure and flow rate of at least one pump; and
at least one interface detection meter in communication with the pipeline assembly, the interface detection meter determining properties of the fluid in the pipeline assembly, and the control assembly controlling the speed and/or the discharge pressure and/or the flow rate according to the properties determined of the fluid in the pipeline assembly.

2. The pump system of claim 1, the control assembly transmitting data of the properties of the fluid and calculating speed set points and/or discharge pressure set points and/or control parameter and/or flow rate set points.

3. The pump system of claim 2, wherein the control assembly comprises a first logic control comprising feed-forward control logic for transmitting the data of the properties of the fluid.

4. The pump system of claim 2, wherein the control assembly comprises second logic control and third logic controls comprising PID control logic for calculating the speed set points and/or the discharge pressure set points and/or flow rate set points.

5. The pump system of claim 1, wherein the pump assembly comprises a plurality of centrifugal pumps arranged in series, parallel or a combination thereof.

6. The pump system of claim 1, wherein the at least one interface detection meter comprises a transit-time ultrasonic meter.

7. The pump system of claim 1, further comprising:
at least one variable speed drive system (VSDS) operably coupled to at least one of the plurality of pump motors of the pump motor assembly.

8. A control system comprising:
at least one interface detection meter in communication with a pipeline assembly for transporting fluid;
a drive assembly controlling speed of at least one pump motor powering at least one pump in communication with the pipeline assembly for transporting the fluid; and
a feed forward control assembly controlling pump speed and/or discharge pressure and/or flow rate of the at least one pump,
wherein a first logic control of the control assembly receives fluid data of the fluid in the pipeline assembly provided by the at least one interface detection meter, and forwards the fluid data to a second logic control for calculating speed set points and/or discharge pressure set points and/or flow rate set points for the feed forward control assembly.

9. The control system of claim 8, wherein the control assembly is configured to detect a fluid interface of a batch change of the fluid transported in the pipeline assembly and automatically adjusts the speed set points and discharge pressure set points in a continuous manner when the fluid interface travels through the pipeline assembly.

10. The control system of claim 8, wherein the speed set points and discharge pressure set points are calculated based upon the fluid data and pump performance data programmed in the first or second logic control.

11. The control system of claim 10, wherein the fluid data and pump performance data are selected from a group consisting of fluid density, fluid viscosity, volumetric fluid flow rate, fluid velocity, fluid pressure, fluid temperature, fluid crude assays, pump performance curves, suction pressure of pump, discharge pressure of pump, and a combination thereof.

12. The control system of claim 10, wherein the at least one interface detection meter is configured as ultrasonic meter.

13. A method for controlling variable speed driven pumps or pump systems comprising:
acquiring real-time fluid data by field instruments of a fluid travelling through a pipeline assembly, and acquiring operational data of a pump system by different units of the pump system, the pump system being operably coupled to the pipeline assembly;
transferring acquired fluid data and operational data to logic controls of the pump system;
processing the acquired fluid data and operational data by the logic controls;
overriding basic pump controls of the pump system based on results provided by the logic controls after the processing of the acquired fluid data and operational data; and
resetting the basic pump controls.

14. The method of claim 13, wherein the acquiring of the real-time fluid data comprises measuring first fluid data and calculating second fluid data.

15. The method of claim 14, wherein the first fluid data comprise at least volumetric flow rate and velocity of the fluid, and wherein the second fluid data comprise at least density and viscosity of the fluid.

16. The method of claim 13, wherein the fluid data are acquired using at least one ultrasonic meter in communication with the pipeline assembly.

17. The method of claim 13, wherein the basic pump controls comprise speed set points, discharge pressure set points and flow set points.

18. The method of claim 17, wherein the processing of the acquired fluid data and operational data includes calculating the speed set points, discharge pressure set points and flow set points by the logic controls.

19. The method of claim 18, further comprising:
automatically adjusting the speed set points and/or discharge pressure set points and/or flow rate set points of a pump unit based upon calculations by the logic control.

20. The method of claim 13, wherein the basic pump controls are reset after a batch change of the fluid travelling in the pipe assembly has been detected and has passed pump units of the pump system.
